(19) United States
(12) Patent Application Publication
(10) Pub. No.: US 2015/0354757 A1
(43) Pub. Date: Dec. 10, 2015

(54) LED LAMP

(71) Applicant: SEOUL SEMICONDUCTOR CO., LTD., Danwon-gu, Ansan-si, Gyeonggi-do (KR)

(72) Inventors: Jin Wook Lee, Ansan-si (KR); Ki Tae Kang, Ansan-si (KR)

(21) Appl. No.: 14/762,780

(22) PCT Filed: Jan. 22, 2014
(86) PCT No.: PCT/KR2014/000639

§ 371 Date: Jul. 22, 2015

(30) Foreign Application Priority Data
Jan. 22, 2013 (KR) 10-2013-0006998

(51) Int. Cl. F21K 99/00; F21V 29/70; F21V 7/00

(52) U.S. Cl. CPC F21K 9/135; F21V 7/0066; F21K 9/56; F21V 29/70; F21Y 2101/02

(57) ABSTRACT

The present invention relates to an LED lamp having improved directivity, which includes: a substrate having light emitting sources mounted on the front surface thereof; an inner cover, which is disposed to cover the substrate and a space to the front of the substrate and which includes a penetration area allowing the penetration of light and a reflection area reflecting light, so that a part of the light emitted from the light emitting sources is reflected by the reflection area and directed toward the sides or the back of the substrate; and an outer cover which is disposed to cover the inner cover and a space to the outside of the inner cover and which allows light to penetrate therethrough.

### TECHNICAL FIELD

The present invention relates to an LED lamp, and more particularly, to an LED lamp which can provide illumination in a lateral or rearward direction as well as in a forward direction.

### BACKGROUND ART

Generally, incandescent bulbs or fluorescent lamps are widely used for indoor or outdoor lighting. However, such incandescent bulbs or fluorescent lamps require frequent replacement due to short lifespan thereof.

To overcome this problem, there have been developed LED lamps using light emitting diodes (LEDs) which exhibit excellent controllability, fast response, high electricity-light conversion efficiency, long lifespan, low power consumption, and high brightness.

Advantageously, LEDs exhibit low power consumption due to high photoelectric conversion efficiency thereof, require no preheating time due to no use of thermal emission or gas discharge emission, and have high switching speed.

In addition, LEDs are highly shock resistant and safe due to the absence of gas or filaments, are driven by constant direct current and thus can reduce power consumption and lessen fatigue of the optic nerve as well as having semi-permanent lifespan and providing lighting effects in various colors, and use small light sources, thereby allowing miniaturization.

A typical LED lamp includes a substrate with a plurality of LED devices mounted thereon, a heat sink having the substrate mounted thereon and dissipating heat generated during light emission of the LED devices, and a transparent cover protecting the LED devices from a surrounding environment.

However, such an LED lamp has an beam angle of 120° to 130° in light emission of the LED devices and thus allows a light distribution only in a substantially forward direction.

Thus, such an LED lamp does not have a light distribution found in incandescent bulbs, i.e. a light distribution wherein light is also distributed in a lateral or rearward direction, and thus fails to secure sufficient illuminance in an interior or exterior space.

### DISCLOSURE

### Technical Problem

The present invention has been conceived to solve such problems in the art and one aspect of the present invention is to provide an LED lamp which has similar light distribution characteristics to incandescent bulbs by including a structure allowing light to be emitted in a lateral or rearward direction as well as in a forward direction.

### Technical Solution

In accordance with one embodiment of the present invention, an LED lamp includes: a substrate with light-emitting sources mounted on a front surface thereof; an inner cover disposed to cover both the substrate and a space in front of the substrate and including a transmissive region transmitting light and a reflective region reflecting light and allowing some fraction of light emitted from the light-emitting sources to be reflected by the reflective region and travel in a lateral or rearward direction of the substrate; and an outer cover disposed to cover both the inner cover and a space surrounding the inner cover and being permeable to light.

In the LED lamp according to the embodiment of the invention, the reflective region may face the light-emitting sources in a rearward direction thereof.

In the LED lamp according to the embodiment of the invention, one surface of the reflective region facing the light-emitting sources may be formed as a curved surface.

In the LED lamp according to the embodiment of the invention, one surface of the reflective region facing the light-emitting sources may be formed as a contoured surface.

In the LED lamp according to the embodiment of the invention, the reflective region may be formed by applying a reflective material to an inner or outer surface of the inner cover.

In the LED lamp according to the embodiment of the invention, the reflective region may be formed by incorporating a reflective material into the inner cover.

In the LED lamp according to the embodiment of the invention, the light-emitting sources may include LEDs emitting any one of red light, green light, and blue light, and the transmissive region may include a fluorescent material such that light emitted from the LEDs is converted into white light while traveling through the transmissive region.

In the LED lamp according to the embodiment of the invention, the fluorescent material may be applied to an inner or outer surface of the inner cover.

In the LED lamp according to the embodiment of the invention, the fluorescent material may be incorporated into the inner cover.

In the LED lamp according to the embodiment of the invention, the inner cover may be integrally formed with the transmissive region and the reflective region.

In the LED lamp according to the embodiment of the invention, the inner cover may be formed by coupling a transmissive section corresponding to the transmissive region to a reflective section corresponding to the reflective region.

The LED lamp may further include a heat sink on which the substrate is mounted.

In the LED lamp according to the embodiment of the invention, the heat sink may be formed with a protrusion protruding forward therefrom inside a front surface of the heat sink and the substrate may be mounted on a front surface of the protrusion.

In the LED lamp according to the embodiment of the invention, the inner cover may be coupled to the protrusion such that the protrusion is inserted into an open rear portion of the inner cover.

In the LED lamp according to the embodiment of the invention, the outer cover may be coupled to an edge of the front surface of the heat sink at a rear end thereof, with the inner cover inserted into an open rear portion of the outer cover.

In the LED lamp according to the embodiment of the invention, the front surface of the protrusion has an area smaller than or equal to that of the substrate.

In the LED lamp according to the embodiment of the invention, the heat sink may be formed with a slanted surface on an outer surface of a front end thereof.

The above features of the present invention will become apparent from the detailed description of the following embodiments in conjunction with the accompanying drawings.

### Advantageous Effects

The present invention provides an LED lamp which includes an inner cover disposed to cover both a substrate with LEDs mounted thereon and a space in front of the substrate and formed with a reflective region reflecting light, and thus allows light emitted from LEDs to be reflected by the reflective region and travel in a lateral or rearward direction of the substrate. Thus, the LED lamp can have light distribution characteristics similar to incandescent bulbs.

### DESCRIPTION OF DRAWINGS

FIG. 1 is a perspective view of an LED lamp according to one embodiment of the present invention.

FIG. 2 is a cut-away perspective view showing main portions of the LED lamp in FIG. 1.

FIG. 3 is an exploded perspective view of the LED lamp in FIG. 1.

FIG. 4 is a sectional view of the LED lamp in FIG. 1.

* List of Reference Numerals

| | |
|---|---|
| 100: LED lamp | 110: Outer cover |
| 120: Inner cover | 121: Reflective region |
| 121a: Reflective section | 122: Transmissive region |
| 122a: Transmissive section | 130: LED module |
| 131: Light-emitting sources (LEDs) | 132: Substrate |
| 140: Heat sink | 141: Protrusion |
| 142: Slanted surface | 143: Cooling fins |
| 150: Power supply unit | 160: Base portion |
| 170: Connector | |

Hereinafter, an LED lamp according to embodiments of the present invention will be described in detail with reference to the accompanying drawings.

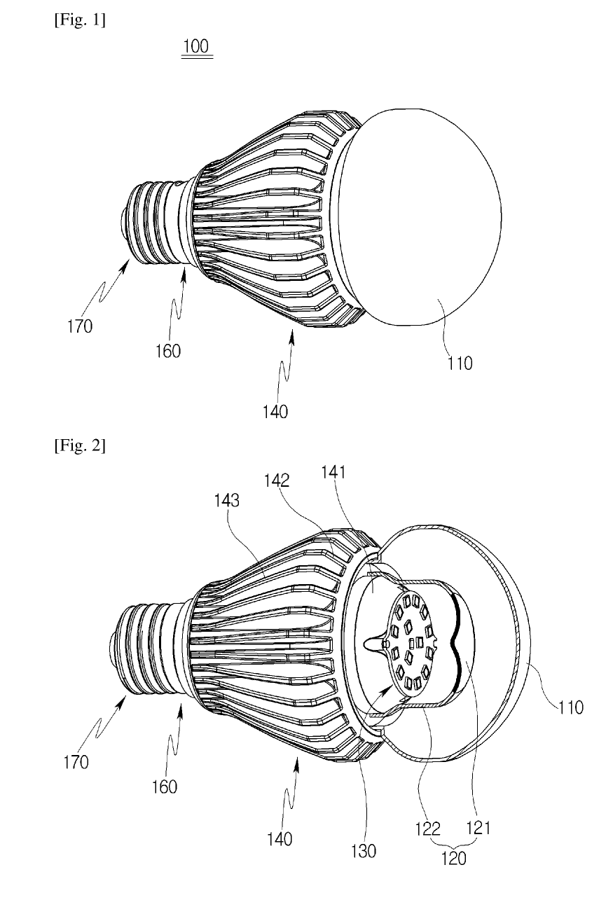

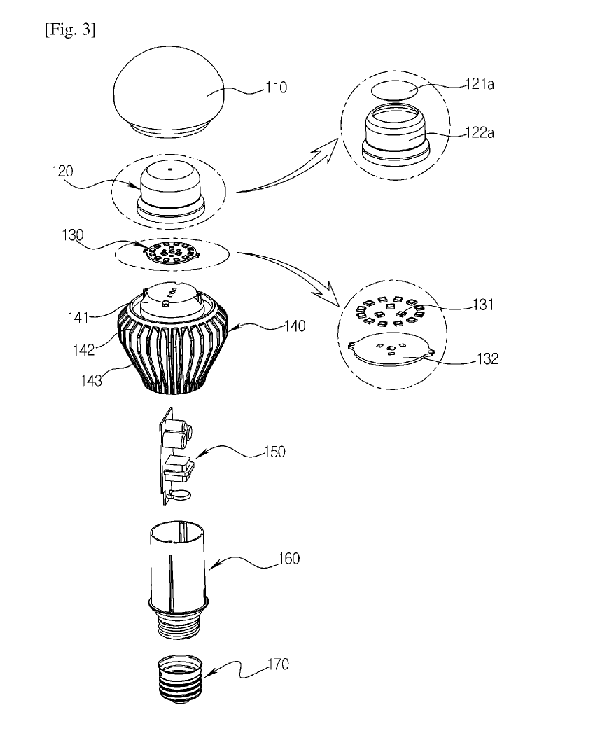

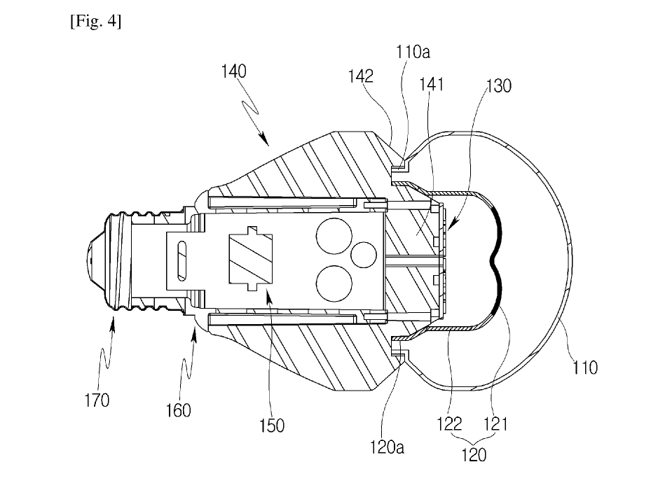

FIG. 1 is a perspective view of an LED lamp according to one embodiment of the present invention, FIG. 2 is a cut-away perspective view showing main portions of the LED lamp in FIG. 1, FIG. 3 is an exploded perspective view of the LED lamp in FIG. 1, and FIG. 4 is a sectional view of the LED lamp in FIG. 1.

As shown in the drawings, an LED lamp 100 according to one embodiment of the invention includes a substrate 132 with light-emitting sources 131 mounted thereon, an inner cover 120 allowing some fraction of light emitted from the light-emitting sources 131 to travel in a lateral or rearward direction, and an outer cover 110 disposed to cover the inner cover 120.

The light-emitting sources 131 are mounted on the substrate 132 and emit light upon application of electric power. The light-emitting sources 131 may include light emitting diodes (LEDs), and the LEDs may emit any one of red light, green light, and blue light. The LEDs may be mounted on the substrate 132 to form an LED module 130.

Specifically, the light-emitting sources 131 may be mounted on a front surface of the substrate 132, and light from the light-emitting sources 131 is emitted into a space in front of the substrate 132.

The inner cover 120 is disposed to cover both the substrate 132 and the space in front of the substrate 132. The inner cover 120 has a function to control light travel direction such that some fraction of light emitted into the space in front of the substrate 132 from the light-emitting sources 131 travels in the lateral or rearward direction rather than in a forward direction of the substrate 132.

To perform this function, the inner cover 120 may include a transmissive region 122 transmitting light and a reflective region 121 reflecting light.

Although the inner cover 120 may have various shapes without limitation, by way of example, the inner cover 120 has a substantially cylindrical shape, which is closed at a front end thereof and open at a rear end thereof.

In addition, by way of a specific example of the transmissive region 122 and the reflective region 121, there is given an example of the inner cover 120 wherein a predetermined region inside the closed front end of the inner cover 120 is the reflective region 121 and the remainder is the transmissive region 122.

However, the above example is provided for illustration only. In the inner cover 120, the reflective region 121 may be present at any location at which light emitted from the light-emitting sources 131 arrives and is not limited to the front end region or a predetermined region inside the front end of the inner cover 120, as in the above example.

The reflective region 121 may include a reflective material to reflect light arriving at the region. The reflective material is a material having high reflection efficiency and may include, for example, a material containing aluminum, chromium, and the like.

The reflective region 121 may be formed by applying the reflective material to an inner or outer surface of the inner cover 120, or by incorporating the reflective material into the inner cover 120 in manufacture of the inner cover 120 such that the inner cover 120 contains the reflective material therein.

Although the reflective region 121 may reflect all light that reaches the reflective region 121, the reflective region may also be formed as a transflective region 122 partially reflecting and partially transmitting light that reaches the corresponding region through adjustment of the amount of the reflective material included in the reflective region 121.

The transmissive region 122 of the inner cover 120 may be formed of various light transmissive materials. Here, when LEDs emitting any one of red light, green light, and blue light are used as light-emitting sources 131, the transmissive region 122 may include a fluorescent material such that light emitted from the LEDs is converted into white light while traveling through the transmissive region 122.

Particularly, when LEDs emitting blue light are used as light-emitting sources 131, a fluorescent material including yellow phosphors may be used by way of a specific example of the fluorescent material.

For example, the transmissive region 122 includes the fluorescent material by applying the fluorescent material to the inner or outer surface of the inner cover 120, or using a material including the fluorescent material in manufacture of the inner cover 120 such that the inner cover 120 contains the fluorescent material therein.

The inner cover 120 may be integrally formed with the transmissive region 122 and the reflective region 121. Alternatively, the inner cover may have a structure including a transmissive section 122a and a reflective section 121a, wherein the transmissive section 122a and the reflective section 121a are coupled to each other to form the inner cover 120. Here, the transmissive section 122a and the reflective section 121a correspond to the transmissive region 122 and the reflective region 121, respectively.

The outer cover 110 may be formed as a transparent cover permeable to light and is disposed to cover both the inner cover 120 and a space surrounding the inner cover 120.

The outer cover 110 may have a function of protecting internal components covered with the outer cover 110, such as the inner cover 120, the substrate 132, and the light-emitting source 131, from a surrounding environment.

Alternatively, the outer cover 110 may be a light diffusion cover allowing light to diffuse and escape therefrom. In this case, light emitted from the light-emitting sources 131 initially passes through the inner cover 120 and then further diffuses while traveling through the outer cover 110 and escapes therefrom. With this structure, the outer cover 110 allows the LED lamp 100 to secure wider beam angle.

Although the outer cover 110 is shown as having a substantially hemispherical shape open at a rear end thereof, the present invention is not limited thereto. It should be understood that the outer cover may have different shapes.

By way of example, a specific arrangement of the outer cover 110 and the inner cover 120 is as follows.

The substrate 132 may be mounted on, for example, a heat sink 140 to dissipate heat generated by the light-emitting sources 131.

The heat sink 140 allows heat generated during light emission of the light-emitting sources 131 to be effectively dissipated, and may be formed of a metallic material having high thermal conductivity, such as aluminum. A plurality of cooling fins 143 may be formed on an outer surface of the heat sink 140 in a circumferential direction thereof to increase a surface area of the heat sink so as to enhance heat dissipation efficiency.

Although not shown in the drawings, the substrate 132 may be directly mounted on a front surface of the heat sink 140. In this case, the inner cover 120 may be coupled at a rear end 120a thereof to the front surface of the heat sink 140 by various coupling methods to cover both the substrate 132 and the space in front of the substrate 132.

Alternatively, the heat sink 140 is formed with a protrusion 141 protruding forward inside the front surface of the heat sink 140, as shown in the drawings, and the substrate 132 may be mounted on a front surface of the protrusion 141.

As described below, light emitted from the light-emitting sources 131 is reflected by the reflective region 121 and travels in the lateral or rearward direction of the substrate 132. Here, when the substrate 132 is tightly mounted on the front surface of the heat sink 140, light is not likely to be emitted rearward due to interference by an edge of the front surface of the heat sink 140. As a result, the LED lamp cannot secure desired beam angle in the rearward direction of the substrate 132.

However, when the heat sink 140 is formed with the protrusion 141 protruding forward inside the front surface thereof and the substrate 132 is mounted on the protrusion, the substrate 132 is spaced forward from the inside of the front surface of the heat sink 140, whereby interference of the edge of the front surface of the heat sink 140 to reflected light can be minimized as compared with when the substrate 132 is tightly mounted on the front surface of the heat sink 140. As a result, the LED lamp can easily secure a desired beam angle in the rearward direction of the substrate 132.

Here, the front surface of the protrusion 141 preferably has an area smaller than or equal to that of the substrate 132 such that light reflected by the reflective region 121 is not interfered with an edge of the front surface of the protrusion 141.

In addition, when the protrusion 141 is too long, the volume of the LED lamp 100 increases proportionally. Thus, it is desirable that the protrusion 141 protrude to have an appropriate length.

As described above, when the substrate 132 is mounted on the front surface of the protrusion 141, the inner cover 120 may be coupled to the protrusion 141. More specifically, as shown in the drawings, the inner cover may be coupled at the rear end 120a thereof to the protrusion 141 such that the protrusion 141 is inserted into an open rear portion of the inner cover 120. Here, coupling may be achieved by various methods, such as press fitting, an adhesive, or screw fastening a thread groove formed in an outer peripheral surface of the protrusion 141 to a thread formed on an inner surface of the rear end 120a of the inner cover.

When the inner cover 120 is coupled to the protrusion in this way, the inner cover 120 is disposed to cover both the substrate 132 and the space in front of the substrate 132.

Here, as described above, the reflective region 121 may be any region of the inner cover 120 so long as light emitted from the light-emitting sources 131 reaches the region without limitation. By way of example, the reflective region 121 is shown as being a predetermined region inside the closed front end of the inner cover 120 in FIG. 4. In this case, the reflective region 121 faces the light-emitting sources 131 in the rearward direction thereof.

When the inner cover 120 is formed with the reflective region 121 in this way, light emitted from the light-emitting sources 131 is reflected by the reflective region 121 and travels in the lateral or rearward direction of the substrate 132 rather than in the forward direction of the substrate 132.

One surface of the reflective section 121 facing the light-emitting sources 131 may have various shapes allowing a sufficient amount of the reflected light to travel in the lateral or rearward direction of the substrate 132.

For example, the one surface of the reflective region 121 may be formed as a curved surface. Alternatively, the one surface of the reflective region may be formed as a contoured surface composed of continuous curved surfaces in a sectional view, as shown in the drawings. As an another alternative, although not shown in the drawings, the one surface of the reflective region may have various different shapes capable of reflecting light at various angles, such as a slanted surface 142, a contoured surface composed of such slanted surfaces 142, and the like

The transmissive region 122 may include all regions excluding the reflective region 121. In the above example wherein a predetermined region inside the front end of the inner cover 120 is the reflective region 121, a side surface region of the inner cover 120 excluding the reflective region 121 is the transmissive region 122.

Some fraction of light emitted from the light-emitting sources 131 directly passes through the transmissive region 122 to be emitted outside the inner cover 120. The rest of the light is reflected by the reflective region 121 and then passes through the transmissive region 122.

As shown in the drawings, the outer cover 110 may be coupled at a rear end 110a thereof to the edge of the front surface of the heat sink 140, with the inner cover 120 inserted into the open rear portion thereof. The outer cover 110 is coupled to the heat sink in this way and disposed to cover both the inner cover 120 and the space surrounding the inner cover 120. In addition, components such as the inner cover 120, the substrate 132, and the light-emitting sources 131 received in an internal space of the outer cover 110 can be protected by the outer cover 110.

When the outer cover 110 is a light diffusion cover and the substrate 132 is mounted on the front surface of the protrusion 141, light passing through the inner cover 120 and traveling in the rearward direction of the substrate 132 travels through a rear region of the outer cover 120, since the substrate 132 is spaced forward from the rear end 110a of the outer cover 110. As a result, light can be diffused and emitted in the rearward direction of the substrate 132. Thus, the LED lamp 100 can secure wider beam angle in the rearward direction of the substrate 132.

The heat sink 140 may be formed with a slanted surface 142 on an outer surface of a front end thereof. For example, the slanted surface 142 may be a slanted surface 142 that increases in outer diameter toward a rear end thereof. When the heat sink is formed with the slanted surface 142, the front surface of the heat sink 140 has a reduced area as compared with when the heat sink is not formed with the slanted surface. Formation of the slanted surface 142 allows light passing through the inner cover 120 and the outer cover 110 to travel in the rearward direction of the substrate 132 without interference with the edge of the front surface of the heat sink 140. Thus, the LED lamp 100 can more easily secure desired beam angle in the rearward direction of the substrate 132.

A base portion 160 for supplying external electric power to the LED lamp 100 may be coupled to a rear side of the heat sink 140. The base portion 160 may receive a power supply 150 to supply electric power to the substrate 132. In addition, the base portion 160 may be formed at a rear end thereof with a socket type connector 170 to supply externally applied electric power to the power supply unit 150.

As described above, the LED lamp 100 according to the embodiment includes the inner cover 120 covering both the substrate 132 and the space in front of the substrate 132 and formed with the reflective region 121, and thus allow light emitted from the light-emitting sources 131 to be reflected by the reflective region 121 and travel in the lateral or rearward direction of the substrate 132. Thus, the LED lamp 100 can have light distribution characteristics similar to incandescent bulbs.

Although some embodiments have been described herein, it should be understood by those skilled in the art that these embodiments are given by way of illustration only and the present invention is not limited thereto. In addition, it should be understood that various modifications, variations, and alterations can be made by those skilled in the art without departing from the spirit and scope of the present invention.

Therefore, the scope of the invention should be limited only by the accompanying claims and equivalents thereof.

### INDUSTRIAL APPLICABILITY

The LED lamp according to the present invention can be used for indoor or outdoor lighting.

1. An LED lamp comprising:
a substrate with light-emitting sources mounted on a front surface thereof;
an inner cover disposed to cover both the substrate and a space in front of the substrate and including a transmissive region transmitting light and a reflective region reflecting light and allowing some fraction of light emitted from the light-emitting sources to be reflected by the reflective region and travel in a lateral or rearward direction of the substrate; and
an outer cover disposed to cover both the inner cover and a space surrounding the inner cover and being permeable to light.

2. The LED lamp according to claim 1, wherein the reflective region faces the light-emitting sources in a rearward direction thereof.

3. The LED lamp according to claim 2, wherein one surface of the reflective region facing the light-emitting sources is formed as a curved surface.

4. The LED lamp according to claim 2, wherein one surface of the reflective region facing the light-emitting sources is formed as a contoured surface.

5. The LED lamp according to claim 1, wherein the reflective region is formed by applying a reflective material to an inner or outer surface of the inner cover.

6. The LED lamp according to claim 1, wherein the reflective region is formed by incorporating a reflective material into the inner cover.

7. The LED lamp according to claim 1, wherein the light-emitting sources comprise LEDs emitting any one of red light, green light, and blue light, and the transmissive region comprises a fluorescent material such that light emitted from the LEDs is converted into white light while traveling through the transmissive region.

8. The LED lamp according to claim 7, wherein the fluorescent material is applied to an inner or outer surface of the inner cover.

9. The LED lamp according to claim 7, wherein the fluorescent material is incorporated into the inner cover.

10. The LED lamp according to claim 1, wherein the inner cover is integrally formed with the transmissive region and the reflective region.

11. The LED lamp according to claim 1, wherein the inner cover is formed by coupling a transmissive section corresponding to the transmissive region to a reflective section corresponding to the reflective region.

12. The LED lamp according to claim 1, further comprising: a heat sink on which the substrate is mounted.

13. The LED lamp according to claim 12, wherein the heat sink is formed with a protrusion protruding forward therefrom inside a front surface of the heat sink and the substrate is mounted on a front surface of the protrusion.

14. The LED lamp according to claim 13, wherein the inner cover is coupled to the protrusion such that the protrusion is inserted into an open rear portion of the inner cover.

15. The LED lamp according to claim 14, wherein the outer cover is coupled to an edge of the front surface of the heat sink at a rear end thereof, with the inner cover inserted into an open rear portion of the outer cover.

16. The LED lamp according to claim 13, wherein the front surface of the protrusion has an area smaller than or equal to that of the substrate.

17. The LED lamp according to claim 13, wherein the heat sink is formed with a slanted surface on an outer surface of a front end thereof.

18. An LED lamp comprising:
a substrate including a front surface and a rear surface;
light-emitting sources mounted on the front surface of the substrate;
an inner cover disposed to cover the substrate and a space in front of the substrate and including a transmissive region transmitting light towards a first direction pointing away from the front surface and a reflective region reflecting light as reflected light and further directing a portion of the reflected light to travel in a second direction different from the first direction; and
an outer cover disposed to cover the inner cover and a space surrounding the inner cover, the outer cover being permeable to light.

19. The LED lamp according to claim 18, wherein the second direction includes a direction pointing to a lateral side or rear of the substrate.

20. The LED lamp according to claim 1, further comprising:
a heat sink on which the substrate is mounted, the head sink including a protrusion toward a front of the heat sink,
wherein the substrate is mounted on the protrusion, and the inner cover is coupled to the protrusion such that the protrusion is inserted into an open rear portion of the inner cover.
